(19) United States
(12) Patent Application Publication
(10) Pub. No.: US 2004/0243780 A1
(43) Pub. Date: Dec. 2, 2004

(54) Processor system

(75) Inventors: Hideaki Fukuda, Fukuoka (JP); Yuichiro Kurihara, Fukuoka (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Sony Corporation

(21) Appl. No.: 10/839,644

(22) Filed: May 5, 2004

(30) Foreign Application Priority Data
May 26, 2003 (JP) P2003-148343

(51) Int. Cl. G06F 12/00

(52) U.S. Cl. 711/168

(57) ABSTRACT

A local memory controller for controlling data transfer to a local memory connected to a processor core section via a local data bus, is disposed outside the processor core section so that a process of transferring data to said local memory and a process by said processor core section can be executed in parallel. A process time of a processor system can be shortened considerably.

### CROSS REFERENCE TO RELATED APPLICATION

The present document is based on Japanese Priority Document JP2003-148343, filed in the Japanese Patent Office on May 26, 2003, the entire contents of which being incorporated herein by reference.

### BACKGROUND OF THE INVENTION

1. Field of the Invention

The present invention relates to a processor system.

2. Description of Related Art

As shown in FIG. 6, in a related art processor system 101, a processor 102 is connected to external memories 104 and input/output devices 105 via a system bus 103, and in the processor 102, a processor core section 106 is connected to a local memory 108 via a local bus 107.

When the processor system 101 executes various processes, the processor 102 executes the following processes.

First, the processor 102 transfers necessary data from the input/output device 105 to the external memory 104 via the system bus 103.

Next, the data is transferred from the external memory 104 to the processor core section 106 (register) via the system bus 103.

Next, the data is transferred from the processor core section 106 to the local memory 108 via the local bus 107.

Next, various processes are performed in accordance with the data stored in the local memory 108, and the process results are stored in the local memory 108.

Next, the stored data is transferred from the local memory 108 to the processor core section 106 via the local data bus 107.

Next, the data is transferred from the processor core section 106 to the external memory 104 via the system bus 103.

Next, the data is transferred from the external memory 104 to the input/output device 105 via the system bus 103.

As above, after the data was transferred to the local memory 108, the related art processor 102 executes various processes so that it is difficult to execute a process at high speed.

This is because it takes a fairly long time to transfer data by using the system bus 103. In addition, since the processor 102 performs data transfer, the processor 102 cannot execute another process during the data transfer process.

A processor has been devised which can transfer data from an external memory directly to a local memory without involving the system bus. For example, refer to Patent Document 1: Japanese Patent Application Publication No. SHO-58-205239.

This processor has a local memory controller in a processor core section. Upon reception of a request from the processor core section, the local memory controller unloads a register from the processor core section, and thereafter data is transferred from the external memory to the local memory directly.

### SUMMARY OF THE INVENTION

Since the processor described in Patent Document 1 is configured so that data is directly transferred from the external memory to the local memory, the time taken to transfer data can be shortened. However, since the local memory controller is provided inside the processor core section, the processor core section cannot execute other process during the data transfer process, so that it is impossible to greatly shorten the process time of the processor.

Since the local memory controller is disposed inside the processor core section, the local memory controller is required to be changed if the specification of the processor core section is altered, resulting in a long time taken to develop a processor.

According to one embodiment of the present invention, a processor system is provided, which includes a local memory controller for controlling data transfer to a local memory connected to a processor core section via a local data bus, the local memory controller being disposed outside the processor core section, wherein a process of transferring data to the local memory and a process by the processor core section are adapted to be executed in parallel.

According to another embodiment of the present invention, it is configured that data to be transferred to the local memory is transferred from an external memory or an input/output device connected to the local memory and the processor core section via a system bus.

According to still another embodiment of the present invention, it is configured that the local memory controller is connected to the processor core section via the local data bus.

According to still another embodiment of the present invention, it is configured that the local memory controller is connected to an input/output device via a request signal line.

In the present invention, a local memory controller for controlling data transfer to a local memory connected to a processor core section via a local data bus, is disposed outside the processor core section. Accordingly, a process of transferring data to the local memory and a process by the processor core section can be executed in parallel.

Further, since the local memory controller is disposed outside the processor core section, the local memory controller is not required to be changed even if the specification of the processor core section is altered, and the time required to develop a processor system can be shortened.

Furthermore, data to be transferred to the local memory is transferred from an external memory or an input/output device connected to the local memory and the processor core section via a system bus. Accordingly, data transfer is possible between the local memories, between the local memory and external memory and between the local memory and input/output device, in parallel to and independently from the process under execution by the processor core section.

Furthermore, since the local memory controller is connected to the processor core section via the local data bus, a control signal can be transmitted quickly from the processor core section to the local memory controller via the local data bus, so that the process time of the processor system can be shortened further.

Furthermore, the local memory controller is connected to an input/output device via a request signal line. It is therefore possible to start data transfer by the local memory controller upon reception of a request signal from the input/output device and to send back the request signal to the input/output device after the data transfer completion by the local memory controller. Accordingly, the data transfer process can be started and terminated without involvement of the processor core section, resulting in a reduced load of the processor core section.

### BRIEF DESCRIPTION OF THE DRAWINGS

FIG. 1 is an illustrative diagram showing a processor system according to the present invention;

FIG. 2 is an illustrative diagram showing a local memory controller;

FIG. 3 is an illustrative diagram showing a transfer source memory space;

FIG. 4 is an illustrative diagram showing a data path;

FIG. 5 is an illustrative diagram showing an address generator; and

FIG. 6 is an illustrative diagram showing a processor system of the related art.

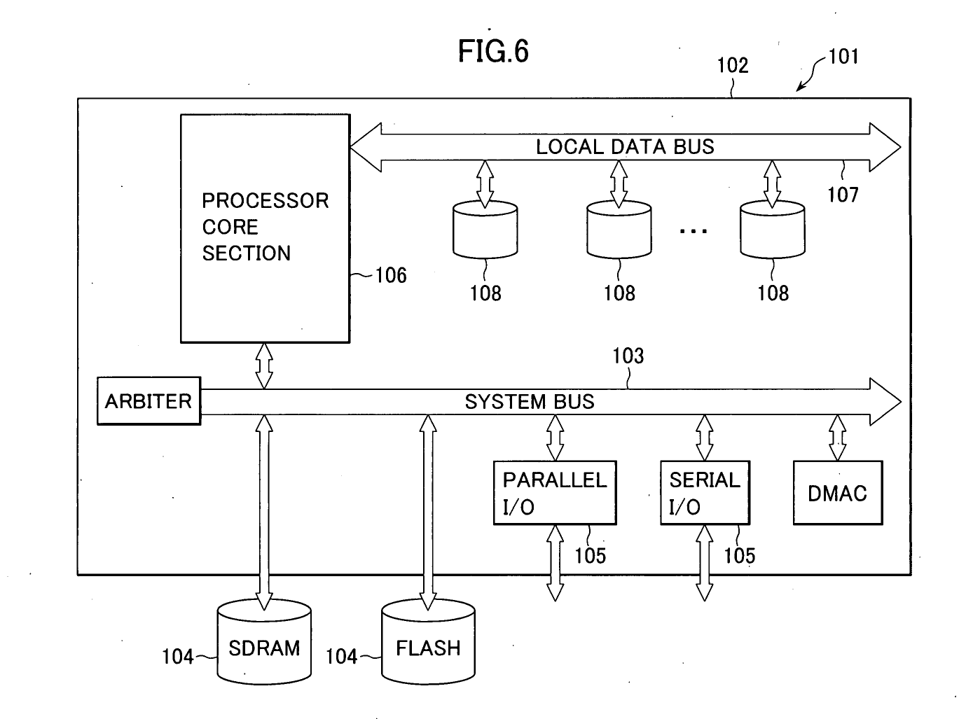

### DESCRIPTION OF THE PREFERRED EMBODIMENT

In a processor system of the present invention, a plurality of local memories and a local memory controller are connected to a processor core section via a local data bus. The local memory has dual ports. One port of the local memory is connected to the processor core section via the local bus, and the other port is connected to the local memory controller.

In the processor system, a plurality of external memories are connected to the processor core section via a system bus, a plurality of input/output devices are connected to the processor core section via a request signal line, and the local memory controller is connected to the external memories and input/output devices.

In the processor system, the local memory controller is disposed outside the processor core section, the local memory controller controlling data transfer to the local memory connected to the processor core section via the local data bus.

With these arrangements, the process of transferring data to the local memory and the process by the processor core section can be executed in parallel so that the process time of the processor system can be shortened considerably.

Since the local memory controller is disposed outside the processor core section, the local memory controller is not required to be changed even if the specification of the processor core section is altered, resulting in a shortened time taken to develop a processor system.

In the processor system, since the local memories, external memories and input/output devices are connected to the local memory controller, data transfer is possible between the local memories, between the local memory and external memory and between the local memory and input/output device, in parallel to and independently from the process under execution by the processor core section.

Further, since the processor core section and local memory controller are connected via the local data bus, a control signal supplied from the processor core section can be transmitted quickly to the local memory controller. The process time of the image processing apparatus can be shortened further.

Furthermore, since the local memory controller and input/output device are connected via a request signal line, data transfer by the local memory controller can be started upon reception of a request signal from the input/output device. Still further, since after the data transfer completion by the local memory controller, a request signal can be sent back to the input/output device, the data transfer process can be started and terminated quickly without involvement of the processor core section, resulting in a reduced load of the processor core section.

With reference to the accompanying drawings, description will be made on an embodiment of a processor system of the present invention.

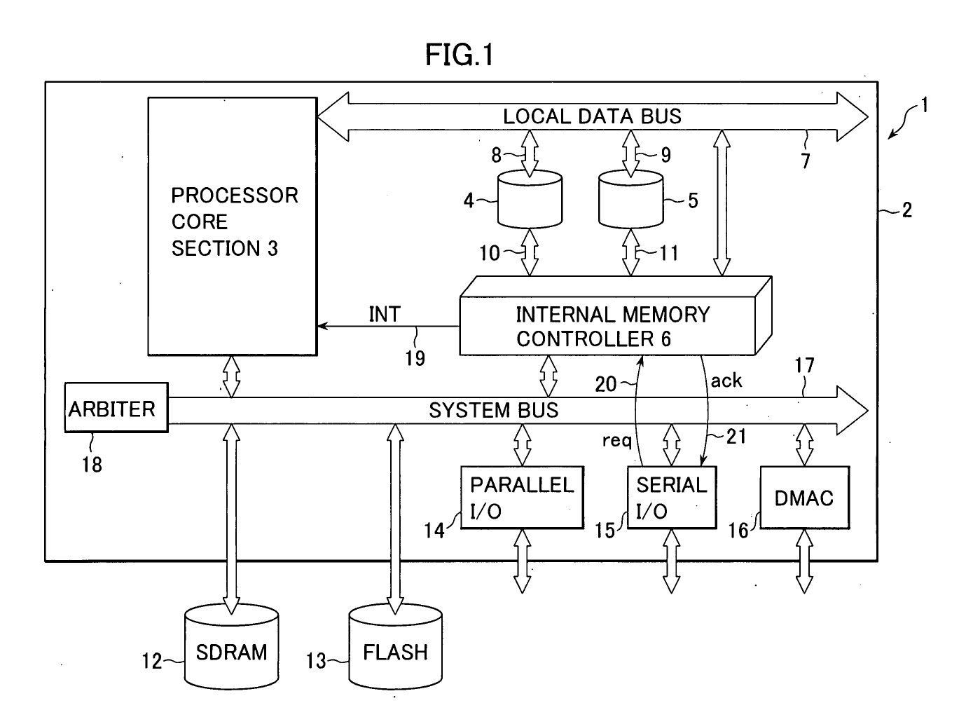

As shown in FIG. 1, in a processor system 1 of the present invention, a processor core section 3 for executing various arithmetic operations is provided inside a processor 2. The processor core section 3 is connected to two dual-port local memories 4 and 5 and a local memory controller 6 via an local data bus 7. The local memory controller 6 controls data transfer to and from the local memories 4 and 5. The local memories 4 and 5 are also connected directly to the local memory controller 6. The local memories 4 and 5 each have dual ports. Ones of input/output ports 8 and 9 are connected to the processor core section 3 via the local data bus 7, and other input/output ports 10 and 11 are connected to the local memory controller 6.

In the processor system 1, external memories 12 and 13, input/output devices 14 and 15 and a direct memory access controller 16 are connected to the processor core section 3 via a system bus 17. Reference numeral 18 represents an arbiter for regulating user requests for the system bus 17.

The processor system 1 also connects the processor core section 3 and local memory controller 6 via the system bus 17. The local memory controller can transmit an interrupt signal to the processor core section 3 via an interrupt signal line 19, and can transmit/receive a request signal to/from the input/output device 15 via request signal lines 20 and 21.

In the processor system 1, the local memory controller 6 disposed outside the processor core section 3 controls data transfer between the local memories 4 and 5, between the local memory 4, 5 and external memory 12, 13 and between the local memory 4, 5 and input/output device 14, 15, in parallel to and independently from the process under execution by the processor core section 3.

The configuration of the local memory controller 6 will be described hereinunder.

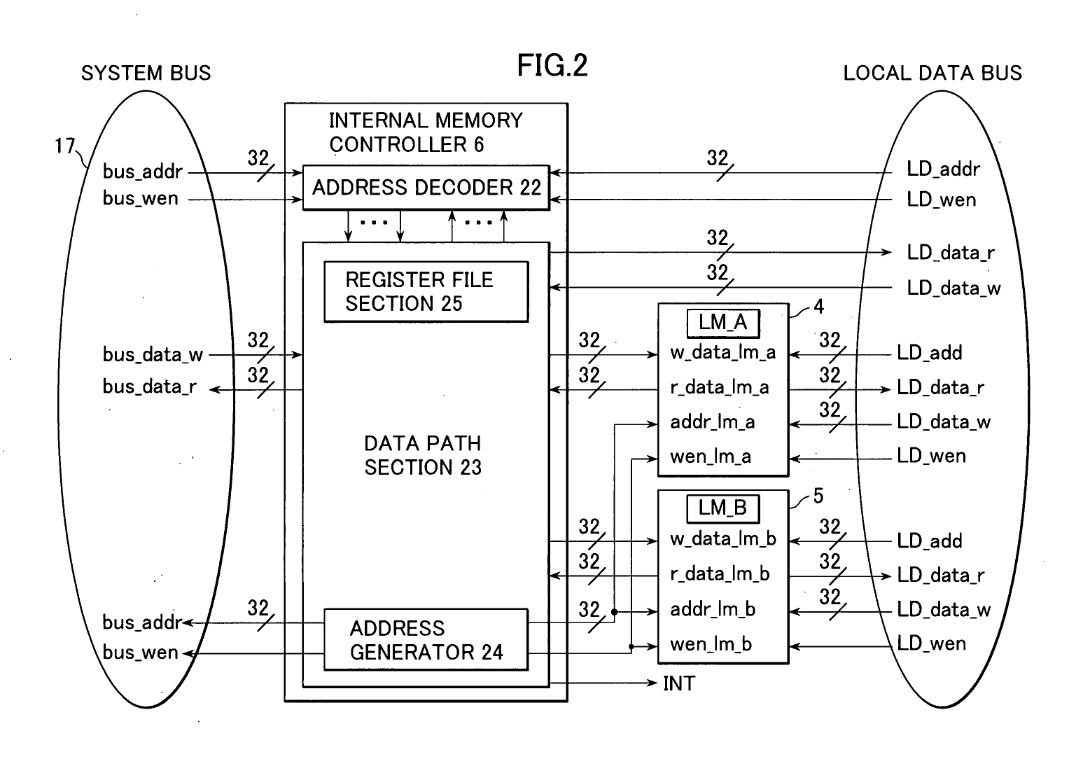

As shown in FIG. 2, the local memory controller 6 is constituted of an address decoder 22, a data path section 23 and an address generator 24.

The local memory controller 6 is mapped to a memory space of the processor 2. This memory map is shown in Table 1. Each mapped register is implemented in a register file 25 provided in the data path section 23.

TABLE 1

| Local Data Bus | System Bus | Register Name | Bit | R/W | Function | Initial Value |
|---|---|---|---|---|---|---|
| 3456_0000h | ABCD_0000h | SADDR | 32 | R/W | Transfer | “X” |
| | | | | | Source | |
| | | | | | Address | |
| 3456_0004h | ABCD_0004h | DADDR | 32 | R/W | Transfer | “X” |
| | | | | | Destination | |
| | | | | | Address | |
| 3456_0008h | ABCD_0008h | BSIZE | 32 | R/W | Rectangle | “X” |
| | | | | | Transfer | |
| | | | | | Block | |
| | | | | | Lateral | |
| | | | | | Size | |
| 3456_000Ch | ABCD_000Ch | BOFFSET | 32 | R/W | Rectangle | “X” |
| | | | | | Transfer | |
| | | | | | Block | |
| | | | | | Lateral | |
| | | | | | Offset | |
| 3456_0010h | ABCD_0010h | CNTRL | 32 | R/W | Control | “0” |
| | | | | | Register | |
| 3456_0014h | ABCD_0014h | START | 32 | W | Transfer | “X” |
| | | | | | Start | |
| | | | | | Register | |
| 3456_0018h | ABCD_0018h | INTREQ | 32 | R/W | Transfer | “0” |
| | | | | | Completion | |
| | | | | | Notice | |
| | | | | | Interrupt | |
| | | | | | Register | |

The address decoder 22 decodes an address supplied from an address bus (bus_addr) of the system bus 17, in accordance with the memory map shown in Table 1.

The function of each register shown in Table 1 will be described.

A register SADDR indicates an address of a transfer source of data transfer, and stores addresses of transfer sources including the local memories 4 and 5, external memories 12 and 13 and input/output devices 14 and 15.

A register DADDR indicates an address of a transfer destination of data transfer, and stores addresses of transfer destinations including the local memories 4 and 5, external memories 12 and 13 and input/output devices 14 and 15.

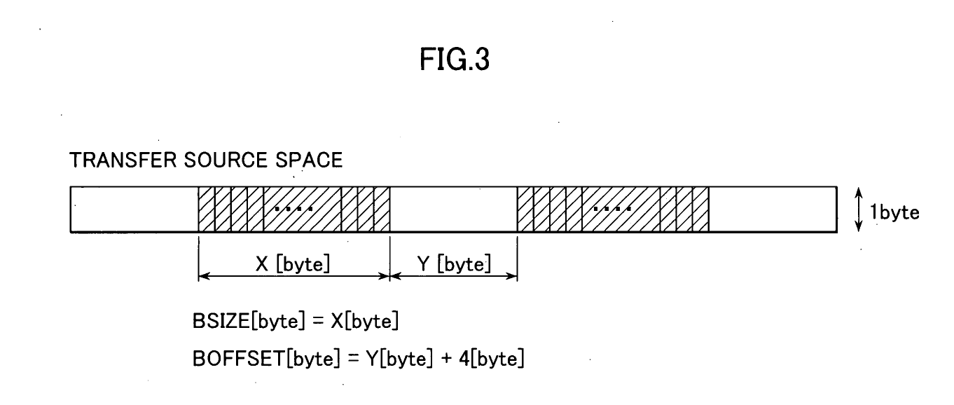

Registers BSIZE and BOFFSET are used for transferring discontinuous data, and as shown in FIG. 3 are used when block data having a size of bytes designated by the register BSIZE is sequentially transferred with a blank space of bytes designated by the register BOFFSET between block data.

A register CNTRL is constituted of control flags for data transfer, the flags being shown in Table 2.

TABLE 2

| | | | | Initial |
|---|---|---|---|---|
| Flag Name | Range | R/W | Function | Value |
| STATUS | [31] | R | Operation | 0: DURING |
| | | | Status | STOP |
| | | | Display (only | |
| | | | read) | |
| | | | 0: FURING STOP | |
| | | | (ACKNOWLEDGE) | |
| | | | 1: FURING DATA | |
| | | | TRANSFER | |
| BGM_EN | [30] | R/W | Transfer | 0: MASK |
| | | | Request | |
| | | | Signal | |
| | | | Enable | |
| | | | 0: MASK | |
| | | | 1: PERMIT | |
| INT_EN | [29] | R/W | Transfer | 0: MASK |
| | | | Completion | |
| | | | Notice | |
| | | | Interrupt | |
| | | | Signal Enable | |
| | | | 0: MASK | |
| | | | 1: PERMIT | |
| SADDR_INIT | [28] | R/W | Transfer | 0: NO |
| | | | Source | RETURN |
| | | | Address After | |
| | | | Transfer | |
| | | | Completion | |
| | | | 0: NO RETURN TO | |
| | | | INITIAL VALUE | |
| | | | 1: RETURN TO | |
| | | | INITIAL VALUE | |
| DADDR_INIT | [27] | R/W | Address After | 0: NO |
| | | | Transfer | RETURN |
| | | | Completion | |
| | | | 0: NO RETURN TO | |
| | | | INITIAL VALUE | |
| | | | 1: RETURN TO | |
| | | | INITIAL VALUE | |
| SADDR_ADD | [26] | R/W | Transfer | 0: UPDATE |
| | | | Source | |
| | | | Address | |
| | | | Update | |
| | | | 0: UPDATE | |
| | | | 1: NO UPDATE | |
| DADDR_ADD | [25] | R/W | Transfer | 0: UPDATE |
| | | | Destination | |
| | | | Address | |
| | | | Update | |
| | | | 0: UPDATE | |
| | | | 1: NO UPDATE | |
| BLOCK_EN | [24] | R/W | Rectangle | 0: NOP |
| | | | Transfer | |
| | | | 0: NOP | |
| | | | 1: OP | |
| BURST_LEN | [23:0] | R/W | Transfer | “0” |
| | | | Burst Length | |
| | | | (Byte | |
| | | | Designate) | |

A register START indicates a start of data transfer. Data transfer starts when arbitrary data is written in this register START.

A register INTREQ notifies data transfer completion by an interrupt signal (refer to Table 3). Normally, this register INTREQ is set to “1” after data transfer completion and reset to “0” in an interrupt routine.

TABLE 3

| Register | | | | Initial |
|---|---|---|---|---|
| Name | Range | R/W | Function | Value |
| | [31:1] | R/W | Don't Care | “0” |
| | [0] | R/W | Transfer | 0: NOP |
| | | | Completion | |
| | | | Notice | |
| | | | Interrupt | |
| | | | Signal | |
| | | | 0: NOP | |
| | | | 1: INTERRUPT | |
| | | | REQUEST | |

The address decoder 22 decodes an address supplied from an address bus (bus_addr) of the system bus 17, in accordance with the memory map shown in Table 1, and the data path section 23 operates to store data supplied from data bus (bus_data_r) of the system bus 17 in a corresponding register. The address decoder 22 also decodes an address supplied from an address bus (LD_addr) of the local data bus 7, in accordance with the memory map shown in Table 1, and the data path section 23 operates to read a corresponding register to data bus (LD_data_r) of the local data bus 7.

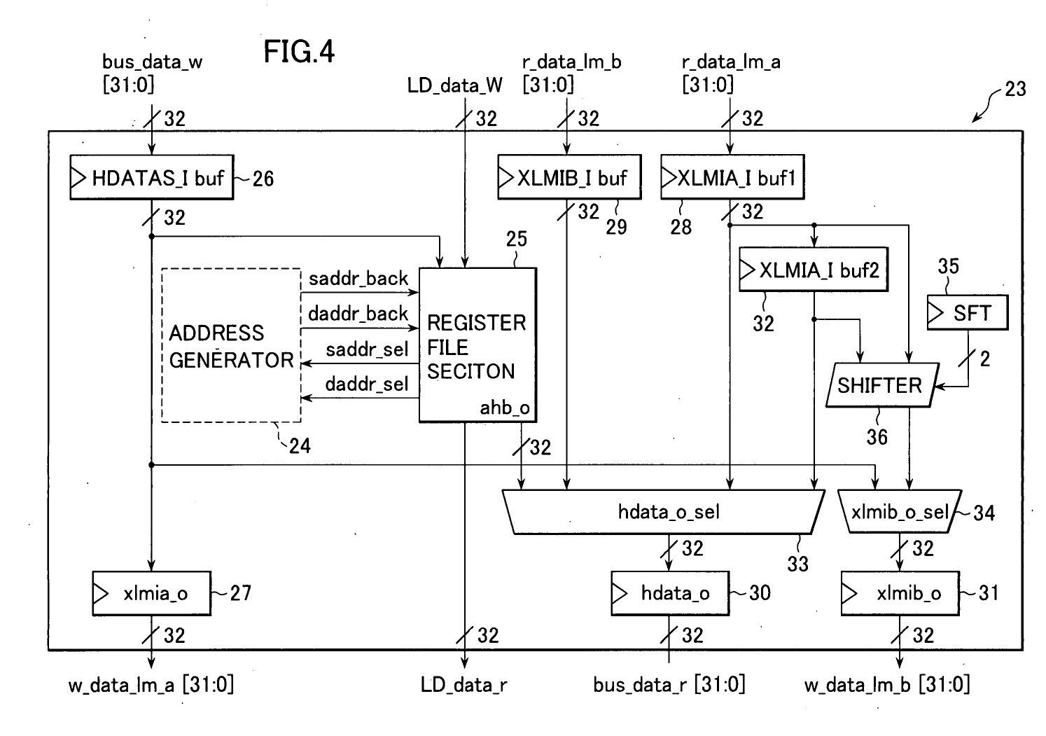

The data path section 23 has the configuration shown in the block diagram of FIG. 4. The data path section 23 includes nine paths in total: a two-way path between the system bus 17 and local memory 4; a two-way path between the system bus 17 and local memory 5; a one-way path from the local memory 4 to local memory 5; a two-way path between the system bus 17 and register file 25; and a two-way path between the local data bus 7 and register file 25; (refer to FIG. 4).

TABLE 4

| | | From Signal | |
|---|---|---|---|
| From | To | Name | To Signal Name |
| System Bus | LM_A | bus_data_w | w_data_lm_a |
| | LM_B | | w_data_lm_b |
| | Register File | | Register file |
| | Section | | section |
| LM_A | System Bus | r_data_lm_a | bus_data_r |
| | LM_B | | w_data_lm_b |
| LM_B | System Bus | r_data_lm_b | bus_data_r |
| Register File | | Register File | |
| Section | | Section | |
| Local Data Bus | Register File | LD_data_w | Register File |
| | Section | | Section |
| Register File | Local Data Bus | Register File | LD_data_r |
| Section | | Section | |

The data path section 23 controls buffers 26 to 32 and selectors 33 and 34 in accordance with the contents of each register in the register file 25, to establish one path by selecting from the nine paths.

More specifically, when the path from the system bus 17 to the local memory 4 is to be established, data from a data bus (bus_data_w) of the system bus 17 is output to an input port (w₁₃ data_lm₁₃ a) of the local memory 4 via the buffer 26 and buffer 27.

When the path from the system bus 17 to the local memory 5 is to be established, data from the data bus (bus₁₃ data_w) of the system bus 17 is output to an input port (w_data_lm_b) of the local memory 5 via the buffer 26, selector 34 and buffer 31.

When the path from the system bus 17 to the register file 25 is to be established, data from the data bus (bus_data_w) of the system bus 17 is input to the register file 25 via the buffer 26.

When the path from the local memory 4 to the system bus 17 is to be established, data from an output port (r_data_lm_a) of the local memory 4 is output to a data bus (bus_data_r) of the system bus 17 via the buffer 28, selector 33 and buffer 30.

When the path from the local memory 4 to the local memory 5 is to be established, data from the output port (r_data_lm_a) of the local memory 4 is output to the input port (w_data_lm_b) of the local memory 5 via the buffer 28, buffer 32, a shifter 36, selector 34 and buffer 31. A buffer 35 and shifter 36 are used for a shift operation, if necessary, during data transfer between the local memories 4 and 5. Not only a shift operation, but also an addition operation and a subtraction operation may be performed. By forming various arithmetic operation units in the paths, various arithmetic operations can be performed during data transfer.

When the path from the local memory 5 to the system bus 17 is to be established, data from an output port (r_data_lm_b) of the local memory 5 is output to the data bus (bus_data_r) of the system bus 17 via the buffer 29, selector 33 and buffer 30.

When the path from the register file 25 to the system bus 17 is to be established, data from an output port (ahb_o) of the register file 25 is output to the data bus (bus_data_r) of the system bus 17 via the selector 33 and buffer 30.

When the path from the local data bus 7 to register file 25 is to be established, data from the register file 25 is input to the register file 25.

When the path from the register file section 25 to the local data bus 7 is to be established, data from the register file section 25 is output to the data bus (LD_data_r) of the local data bus 7.

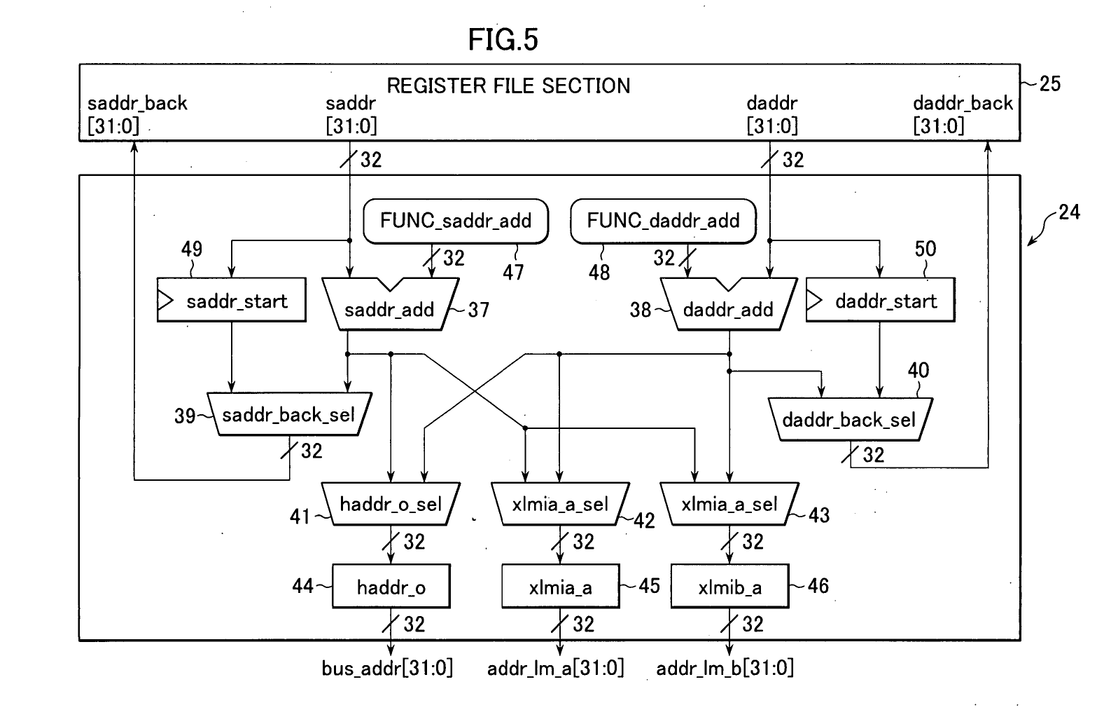

The address generator 24 has the configuration shown in the block diagram of FIG. 5. The address generator 24 generates an address of a transfer source or destination by controlling adders 37 and 38, selectors 39 to 43, buffers 44 to 46 and function operation units 47 and 48 in accordance with the contents of the register SADDR indicating a transfer source address, register DADDR indicating a transfer destination address and control register CNTRL respectively stored in the register file 25.

The truth table of the function operation unit 47 is shown in Table 5. The function operation unit 47 outputs “4” if a SADDR_ADD flag of the control register CNTRL is “0”, “4” being added at the adder 37 to advance the transfer source address by 4 bytes. If the SADDR_ADD flag of the control register CNTRL is “1”, then “0” is output so as not to renew the transfer source address.

TABLE 5

| CNTRL.SADDR_ADD | FUNC_saddr_add |
|---|---|
| 0 | 4 |
| 1 | 0 |

The truth table of the function operation unit 48 is shown in Table 6. The function operation unit 48 outputs “4” if a DADDR_ADD flag of the control register CNTRL is “0”, “4” being added at the adder 38 to advance the transfer destination address by 4 bytes. If the DADDR_ADD flag of the control register CNTRL is “1”, then “0” is output so as not to renew the transfer destination address.

TABLE 6

| CNTRL.DADDR_ADD | FUNC_daddr_add |
|---|---|
| 0 | 4 |
| 1 | 0 |

The address generator 24 has registers 49 and 50, the register 49 storing an address of a transfer source at the start of data transfer and the register 50 storing an address of a transfer destination at the start of data transfer. After the data transfer, the addresses at the data transfer start are returned back to the register SADDR and register DADDR in the register file 25.

The address generator 24 outputs an address via the selector 41 and buffer 44 when data is to be transferred to the system bus 17, outputs an address via the selector 42 and buffer 45 when data is to be transferred to the local memory 4, and outputs an address via the selector 43 and buffer 46 when data is to be transferred to the local memory 5.

The processor system 1 constructed as above transfers data in the manner described hereinunder.

First, a path is established from the system bus 17 to register file 25, and the processor core section 3 sets a transfer source address and transfer destination address in respective registers in the register file 25.

Next, arbitrary data is written from the processor core section 3 in the transfer start register START in the register file 25.

The local memory controller 6 transfers data at the transfer source address to the transfer destination address independently from the process under execution by the processor core section 3. In this case, in the local memory controller 6, the address generator 24 generates addresses of the transfer source and destination, and the data path section 23 establishes a necessary path.

After the data transfer is completed, an interrupt signal is sent to the processor core section 3 via the interrupt signal line 19.

In the above description, the system bus 17 is used for transferring data from the processor core section 3 to the register file 25. Instead of the system bus 17, the local data bus 7 may be used if the processor core section 3 and local memory controller 6 are connected together by the local data bus 7.

If the data transfer destination is the input/output device 15, data may be written directly in the transfer start register START in the register file 25 via the request signal line 20 to start data transfer. Thereafter, an acknowledge signal is sent to the input/output device 15 via the request signal line 21 in place of the interrupt signal line 19.

Finally, the embodiments and examples described above are only examples of the present invention. It should be noted that the present invention is not restricted only to such embodiments and examples, and various modifications, combinations and sub-combinations in accordance with its design or the like may be made without departing from the scope of the present invention.

What is claimed is:

1. A processor system comprising:
a local memory controller for controlling data transfer to a local memory connected to a processor core section via a local data bus, said local memory controller being disposed outside said processor core section,
wherein a process of transferring data to said local memory and a process by said processor core section are adapted to be executed in parallel.

2. The processor system according to claim 1, wherein data to be transferred to said local memory is transferred from an external memory or an input/output device, which are connected to said local memory and said processor core section via a system bus.

3. The processor system according to claim 1, wherein said local memory controller is connected to said processor core section via said local data bus.

4. The processor system according to claim 2, wherein said local memory controller is connected to said processor core section via said local data bus.

5. The processor system according to claims 1, wherein said local memory controller is connected to an input/output device via a request signal line.

6. The processor system according to claims 2, wherein said local memory controller is connected to an input/output device via a request signal line.

7. The processor system according to claim 3, wherein said local memory controller is connected to an input/output device via a request signal line.

8. The processor system according to claim 4, wherein said local memory controller is connected to an input/output device via a request signal line.
